(19) United States
(12) Patent Application Publication
(10) Pub. No.: US 2022/0029320 A1
(43) Pub. Date: Jan. 27, 2022

(54) CABLE AND IMAGE TRANSMISSION SYSTEM

(71) Applicant: FUJIKURA LTD., Tokyo (JP)

(72) Inventor: Yoshinori Arai, Chiba (JP)

(73) Assignee: FUJIKURA LTD., Tokyo (JP)

(21) Appl. No.: 17/297,630

(22) PCT Filed: Nov. 28, 2019
(86) PCT No.: PCT/JP2019/046573

§ 371 Date: May 27, 2021

(30) Foreign Application Priority Data
Nov. 28, 2018 (JP) 2018-222903

(51) Int. Cl. H01R 12/53; H01R 13/717; H01R 12/73; H01B 9/00

(52) U.S. Cl. CPC H01R 12/53; H01R 13/7172; H01R 2201/26; H01B 9/005; H01R 13/7175; H01R 12/732

(57) ABSTRACT

A cable includes a transmission line and a connector disposed on at least one end of the transmission line. The connector includes a housing to which the transmission line is connected and a terminal group that protrudes in a specific direction different from a direction parallel to a longest side of the housing. The terminal group is a terminal group for board-to-board connection.

### BACKGROUND

### Technical Field

The present invention relates to a cable which transmits signals. The present invention also relates to an image transmission system which includes the cable.

### Related Art

Cables having both ends provided with connectors, respectively, are widely used for transmission of signals (including, for example, an image signal, which may include a clock signal for synchronization and/or a bit signal for signal balancing). One of the connectors provided at one end of the cable is connected to a device which acts as a signal source, while the other one of the connectors provided at the other end of the cable is connected to a device which acts as a signal destination. For example, Patent Document 1 discloses a cable which has an end provided with an active connector.

### PATENT LITERATURE

Patent Literature 1: Japanese Patent Application Publication, Tokukaishou, No. 62-95509

A configuration of a conventional cable will be explained below with reference to FIG. 5. FIG. 5 is a perspective view illustrating a typical conventional cable 5 together with a device 6 to which the conventional cable 5 is connected. In FIG. 5, (a) shows a state prior to connection of the cable 5 to the device 6, while (b) shows a state after connection of the cable 5 to the device 6.

The cable 5 has one end provided with a connector 51. This connector 51 includes a terminal group 511 which protrudes in a longest side direction D1 of a housing 510. Accordingly, when the connector 51 is connected to the device 6, the connector 51 protrudes (projects) from the device 6 by a size of the housing 510 in the longest side direction D1. In this configuration, the connector 51 protruding (projecting) from the device 6 may cause difficulties of doing work on the device 6 or require a wide space for placing the connector 51 on the periphery of the device 6. Further, according to this configuration, the connector 51 or the device 6 may be easily damaged due to a contact of an object with the connector 51.

### SUMMARY

One or more embodiments provide a cable which, when a connector is connected to a device (such as an apparatus or a board), can reduce a length of protrusion of the connector from the device as compared to a conventional cable.

A cable in accordance with one or more embodiments includes: a transmission line; and a connector provided at at least one end of the transmission line, the connector including a housing to which the transmission line is connected, and a terminal group protruding in a specific direction different from a direction parallel to a longest side of the housing, the terminal group being a terminal group for board-to-board connection.

A cable in accordance with one or more embodiments makes it possible to provide a cable which, when a connector is connected to a device (such as an apparatus or a board), can reduce a length of protrusion of the connector from the device as compared to a conventional cable.

An image transmission system in accordance with one or more embodiments makes it possible to provide an image transmission system which can reduce (i) a length of protrusion of a connector from an imaging board and (ii) a length of protrusion of the connector from a signal processing board, as compared to a conventional image transmission system.

### BRIEF DESCRIPTION OF THE DRAWINGS

FIG. 1 is a perspective view illustrating a cable in accordance with Embodiment 1.

FIG. 2 is a perspective view illustrating a Variation of the cable illustrated in FIG. 1.

FIG. 3 is a perspective view illustrating a cable in accordance with Embodiment 2.

FIG. 4 is a block diagram of an image transmission system including the cable illustrated in FIG. 3.

FIG. 5 is a perspective view illustrating a typical conventional cable.

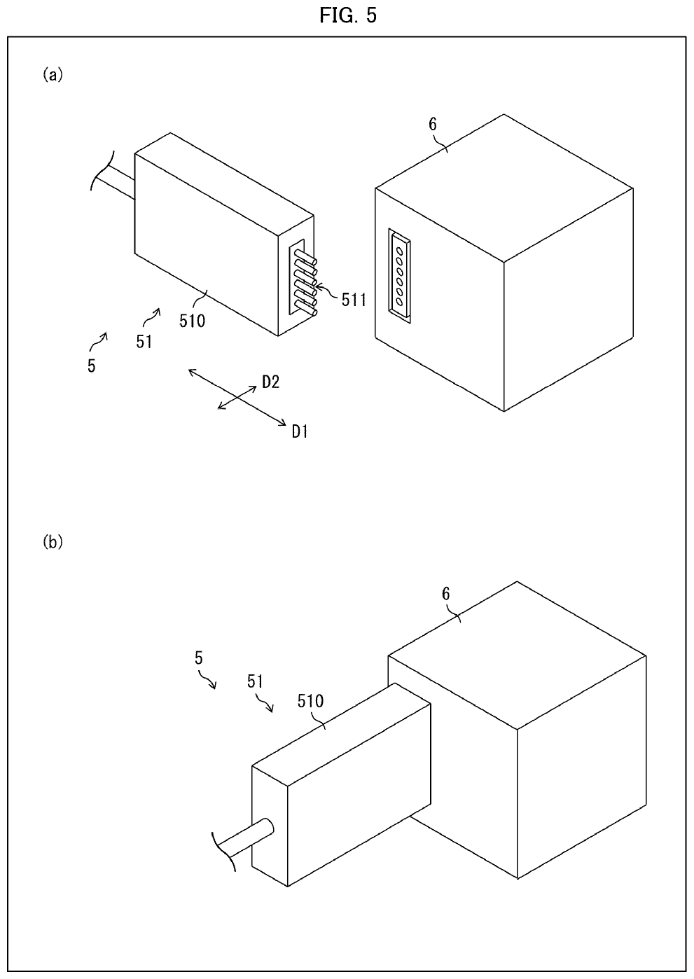

### DETAILED DESCRIPTION

### Embodiment 1

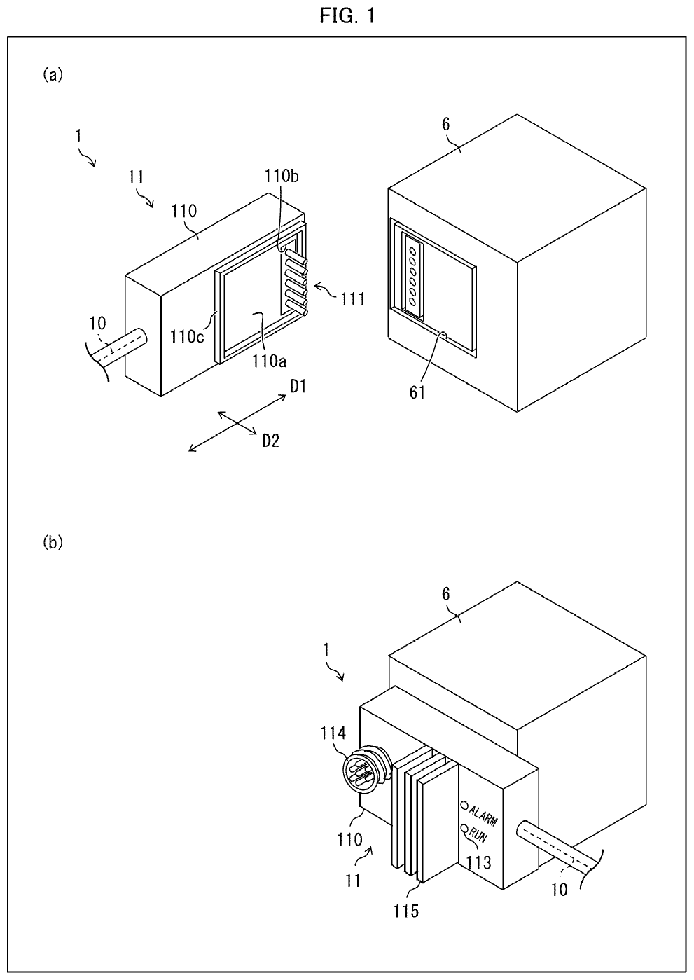

The following will discuss a cable 1 in accordance with Embodiment 1, with reference to FIG. 1. FIG. 1 is a perspective view illustrating the cable 1 together with a device 6 (one example of “device” in Claims) to which the cable 1 is connected. In FIG. 1, (a) shows a state prior to connection of the cable 1 to the device 6, while (b) shows a state after connection of the cable 1 to the device 6.

The cable 1 is a cable having at least one end (both ends in Embodiment 1) provided with a connector 11.

In Embodiment 1, the cable 1 is an active optical cable. Accordingly, the cable 1 includes an optical fiber 10 which is optically connected to the connector 11. The optical fiber 10 is an example of a transmission line described in Claims. Further, the connector 11 includes a built-in transmitting circuit (not illustrated) for converting an electrical signal outputted by the device 6 to an optical signal which is to be transmitted via the optical fiber 10, and a built-in receiving circuit (not illustrated) for converting the optical signal received via the optical fiber 10 to an electrical signal which is to be inputted to the device 6. Therefore, the cable 1 makes it possible to transmit signals faster than metal cables. Note that in Embodiment 1, the device 6 is assumed to be a camera. However, the device 6 is not limited to a camera, and can be any device having a function of signal transmission via the cable 1 and a function of signal reception via the cable 1.

The connector 11 includes: a housing 110 to which the optical fiber 10 is connected; a board (not illustrated) on which the transmitting circuit and/or the receiving circuit is/are mounted and which is built in the housing 110; and a terminal group 111 which protrudes from the board, in a specific direction different from a longest side direction D1 (direction parallel to a longest side) of the housing 110 (in Embodiment 1, the specific direction is a shortest side direction D2, that is, a direction parallel to a shortest side of the housing 110, in other words, a direction different from a lead-out direction in which the transmission line (optical fiber 10) is led out from the housing 110; the same applies below to a direction different from a lead-out direction in which a transmission line (optical fiber 20) is led out from a housing 210). The terminal group 111 is provided on a surface which has a largest area among six surfaces constituting surfaces of the housing 111. In the cable 1, the optical fiber 10 is led out from the housing 110 along the longest side direction D1 (parallel to the longest side direction in Embodiment 1). Therefore, the longest side direction D1 is an example of the lead-out direction described in Claims. In other words, the terminal group 111 protrudes from the board, in a direction different from the lead-out direction. The terminal group 111 is provided mainly for inputting, to the transmitting circuit, an electrical signal outputted by the device 6 and/or for inputting, to the device 6, an electrical signal outputted by the receiving circuit. The terminal group 111 is constituted by a plurality of terminals which are provided along the direction different from the lead-out direction of the optical fiber 10 (in Embodiment 1, along a direction orthogonal to the lead-out direction) and which are aligned in a row, as illustrated in FIG. 1.

In Embodiment 1, the housing 110 is a closed housing in which a space (hereinafter, also referred to as “internal space”) present inside the housing 110 is closed by an outer wall 110a in the direction in which the terminal group 111 protrudes. The terminal group 111 is accessible from the outside through an opening 110b that is provided in the outer wall 110a.

Further, in Embodiment 1, the terminal group 111 is a terminal group for board-to-board connection. The terminal group for board-to-board connection here refers to a terminal group which is for in-device connection and which is originally intended to electrically connect boards to each other. Therefore, the terminal group 111 can transmit signals faster than a terminal group which is for inter-device connection and which is intended to electrically connect devices to each other. Meanwhile, in the case of a terminal group for a press-fit type pin header, terminals are assumed to be inserted into through holes. Accordingly, it is necessary to increase a distance between terminals of such a terminal group in accordance with a distance between through holes. This results in an increased size of the terminal group. In contrast, the terminal group 111 for board-to-board connection can have a smaller distance between terminals than the terminal group for a press-fit type pin header. As a result, the terminal group 111 can have a reduced size.

As described above, a conventional cable 5 has an end provided with a connector 51, and this connector 51 includes a terminal group 511 which protrudes in a longest side direction D1 of a housing 510. Accordingly, when the connector 51 is connected to the device 6, the connector 51 protrudes from the device 6 by a size of the housing 510 in the longest side direction D1.

In contrast, in the cable 1 in accordance with Embodiment 1, the connector 11 includes the terminal group 111 which protrudes in the direction different from the longest side direction D1 of the housing 110 (in Embodiment 1, the shortest side direction D2). Accordingly, when the connector 11 is connected to the device 6, the connector 11 protrudes from the device 6 by a size of the housing 110 in the shortest side direction D2. Therefore, the cable 1 in accordance with Embodiment 1 makes it possible to reduce a length of protrusion of the connector 11 from the device 6 as compared to the conventional cable 5, when the connector 11 is connected to the device 6.

Further, the cable 1 in accordance with Embodiment 1 is configured such that, when the connector 11 is connected to the device 6, an outer surface (one example of “first surface” in Claims) of the outer wall 110a of the housing 110 comes in surface contact with a surface (one example of “second surface” in Claims) of the device 6. Therefore, it is possible to reduce damage which may occur to terminals of the connector 11 and of the device 6 in a case where the connector 11 connected to the device 6 is loose and shaky. In addition, as compared to a case where the outer surface of the outer wall 110a of the housing 110 is not in surface contact with the surface of the device 6, it is possible to further reduce a length of protrusion of the connector 11 from the device 6 when the connector 11 is connected to the device 6.

The outer wall 110a of the housing 110 and the surface of the device 6 may be provided, respectively, with fitting portions which are to be fitted to each other. This makes it possible to reduce a load on the terminal group 111 of the connector 11 by suppressing movement of the connector 11 in a direction parallel to the surface of the device 6, while the connector 11 is connected to the device 6. FIG. 1 illustrates, as an example, a configuration in which a raised portion 110c is provided, as one of such fitting portions, on the outer wall 110a of the housing 110 and a recessed portion 61 is provided, as the other one of such fitting portions, on the device 6. It should be noted that although FIG. 1 illustrates a rib-type raised portion as an example of the raised portion 110c and a groove-type recessed portion as an example of the recessed portion 61, the raised portion 110c and the recessed portion 61 are not limited to such portions. It is possible to use, for example, a pin-type raised portion as the raised portion 110c, and a pinhole-type recessed portion as the recessed portion 61.

The connector 11 further includes an indicator 113. The indicator 113 is provided on a surface opposite to the surface on which the terminal group 111 is provided, among the surfaces constituting the surfaces of the housing 110. The indicator 113 is an indicator that operates on the basis of a control signal which is supplied from the device 6 via the terminal group 111. The indicator 113 is, for example, a lamp which uses a light emitting diode. In the cable 1, the terminal group 111 is arranged to protrude in the direction different from the longest side direction D1 of the housing 110 (in Embodiment 1, the shortest side direction D2). Accordingly, when the connector 11 is connected to the device 6, the connector 11 is likely to cover a larger area of the surface of the device 6. In some cases, the connector 11 may cover over an indicator which is provided on the device 6. In such a case, the indicator 113 which is provided on the connector 11 functions in place of the indicator which is provided on the device 6. That is, even in a case where the connector 11 covers over the indicator which is provided on the device 6, it is possible to indicate a state of the device 6 to a user by use of the indicator 113 which is provided on the connector 11. Although FIG. 1 illustrates a configuration in which the indicator 113 is provided on the surface opposite to the surface on which the terminal group 111 is provided, among the surfaces constituting the surfaces of the housing 110, one or more embodiments of the present invention are not limited to such a configuration. For example, the indicator 113 may be provided on a surface orthogonal to the surface on which the terminal group 111 is provided, that is, on a side surface of the housing 110, among the surfaces constituting the surfaces of the housing 110. Further, the indicator 113 is not limited, in terms of a direction, to the surface opposite to the surface on which the terminal group 111 is provided. That is, the indicator 113 can be provided on a surface of the housing 110 of the connector 11 in any direction except for a direction of the surface on which the terminal group 111 is provided.

The connector 11 further includes a connecting terminal 114. The connecting terminal 114 is provided on the surface opposite to the surface on which the terminal group 111 is provided, among the surfaces constituting the surfaces of the housing 110. The connecting terminal 114 is connected to the terminal group 111 inside the housing 110. When (i) the terminal group 111 of the connector 11 is connected to the device 6 and (ii) the connecting terminal 114 of the connector 11 is connected to an external device, the connecting terminal 114 functions as a terminal for supplying, to the external device, signals which are outputted from the device 6 and/or for inputting, to the device 6, signals which are supplied from the external device.

In the cable 1, the terminal group 111 is arranged to protrude in the direction different from the longest side direction D1 of the housing 110 (in Embodiment 1, the shortest side direction D2). Accordingly, when the connector 11 is connected to the device 6, the connector 11 is likely to cover a larger area of the surface of the device 6. In some cases, the connector 11 may cover over a connecting terminal which is provided on the device 6. In such a case, the connecting terminal 114 which is provided on the connector 11 functions in place of the connecting terminal which is provided on the device 6. That is, even in a case where the connector 11 covers over the connecting terminal which is provided on the device 6, it is possible to input, to the device 6, signals which are supplied from the external device, and/or supply, to the external device, signals which are outputted from the device 6, by using the connecting terminal 114 which is provided on the connector 11. Note that, in a case where (i) the connecting terminal group 111 of the connector 11 is connected to the device 6 and (ii) the connecting terminal 114 of the connector 11 are connected to an external device, the connecting terminal 114 can be used for inputting, to the device 6, power which is supplied from the external device. Further, the surface on which the connecting terminal 114 is provided is not limited to the surface opposite to the surface on which the terminal group 111 is provided. That is, the connecting terminal 114 can be provided on a surface of the housing 110 of the connector 11 in any direction except for the direction of the surface on which the terminal group 111 is provided.

The connector 11 further includes a heat dissipation structure 115. The heat dissipation structure 115 is provided on the surface opposite to the surface on which the terminal group 111 is provided, among the surfaces constituting the surfaces of the housing 110. This makes it possible to efficiently dissipate heat which has been conducted from the device 6 to the connector 11. FIG. 1 illustrates a heatsink as an example of the heat dissipation structure 115, but the heat dissipation structure 115 is not limited to this. That is, any structure that promotes dissipation of heat from the connector 11 can be used as the heat dissipation structure 115. Further, the surface on which the heat dissipation structure 115 is provided is not limited to the surface opposite to the surface on which the terminal group 111 is provided. That is, the heat dissipation structure 115 can be provided on a surface of the housing 110 of the connector 11 in any direction except for the direction of the surface on which the terminal group 111 is provided.

Further, as illustrated in (a) and (b) of FIG. 1, in the cable 1, the optical fiber 10 and the connector 11 is fixed to each other. More specifically, the optical fiber 10 is optically and directly connected to both of the transmitting circuit and the receiving circuit (illustrated in neither (a) of FIG. 1 nor (b) of FIG. 1) which are built in the connector 11. However, in one or more embodiments of the present invention, the optical fiber 10 may be optically connected to one or both of the transmitting circuit and the receiving circuit via an optical connector(s). According to this configuration, in a case where one or both of the transmitting circuit and the reception circuit of the connector 11 need to be replaced (e.g., in a case where one or both of the transmitting circuit and the receiving circuit break down), it is possible to replace only the connector 11 without replacing the optical fiber 10.

Note that though Embodiment 1 has described the cable 1 including the optical fiber 10 as a transmission line, one or more embodiments of the present invention are not limited to such a configuration. That is, the cable 1 may include a transmission line (e.g., a metal wire) that is not an optical fiber, in place of the optical fiber 10 or in addition to the optical fiber 10. That is, one or more embodiments of the present invention can be applied to any of an optical cable using an optical fiber as a transmission line, a metal cable using a metal line as a transmission line, and a composite cable using both of an optical fiber and a metal line as a transmission line. Further, when the cable 1 includes a metal wire, the metal wire and the connector 11 may be electrically connected to each other via an electrical connector. In this configuration, even in a case where the cable 1 includes a metal wire, it is possible to replace only the connector 11 without replacing the optical fiber 10.

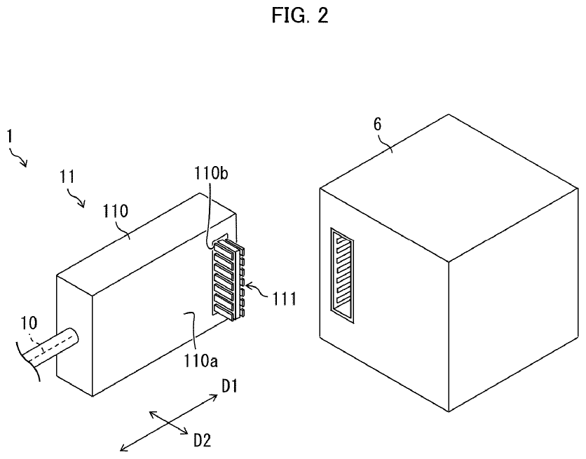

Further, although Embodiment 1 has described a configuration in which the terminal group 111 includes a plurality of terminals which are provided along the direction orthogonal to the lead-out direction of the optical fiber 10 and which are aligned in a row, one or more embodiments of the present invention are not limited to such a configuration. For example, it is possible to employ a configuration in which the terminal group 111 includes a plurality of terminals which are provided along the direction orthogonal to the lead-out direction of the optical fiber 10 and which are aligned in two rows. FIG. 2 illustrates such a Variation. In a case where the plurality of terminals constituting the terminal group 111 are aligned in a row as illustrated in FIG. 1, space-saving is possible by reducing a space necessary for providing the terminal group 111 which is capable of transmitting a plurality of signals. On the other hand, FIG. 2 illustrates a configuration in which a plurality of terminals constituting the terminal group 111 are aligned in two rows. Employing such a configuration makes it possible to double the number of terminals while keeping space-saving performance. It is also possible to improve mechanical stability (e.g. fitting stability) in regard to connection with the device 6. In particular, in the case of a configuration where a partition wall is provided between the two rows of the terminals constituting the terminal group 111, it is possible to further improve the fitting stability by fitting the partition in a recessed portion of the device. Note that these configurations are characteristics of a terminal group for board-to-board connection and are not used in for example, a terminal group which is for a press-fit type pin header and which is assumed to be inserted into through holes.

The terminals constituting the terminal group 111 illustrated in FIG. 1 are each columnar, whereas the terminals constituting the terminal group 111 illustrated in FIG. 2 each have a thin plate shape. Further, in the terminal group 111 illustrated in FIG. 2, adjacent terminals are arranged such that side edge surfaces each having a small area, rather than main surfaces each having a large area, face each other. This configuration is intended to reduce a coupling capacitance between the adjacent terminals. As a result, it is possible to not only widen a transmission band of each of the terminals but also reduce crosstalk between the adjacent terminals, even in a case where a distance between the adjacent terminals is small. Note that the terminal group for board-to-board connection has a smaller distance between terminals than the terminal group for a press-fit pin type header. The terminal group 111 can not only sufficiently widen the transmission band of each of the terminals but also sufficiently reduce crosstalk between the adjacent terminals, even in a case where the terminal group 111 is used as a terminal group for board-to-board connection.

Also note that the number of terminals is four or more in both of the terminal group 111 illustrated in FIG. 1 and the terminal group 111 illustrated in FIG. 2. This makes it possible to transmit one or more sets of differential signals by using, for example, a first terminal as a ground line, a second terminal as a signal line, a third terminal as another signal line, and a fourth terminal as another ground line. It is thus possible to provide the cable 1 capable of carrying out low-noise signal transmission between the cable 1 and the device 6 to which the cable 1 is connected.

### Embodiment 2

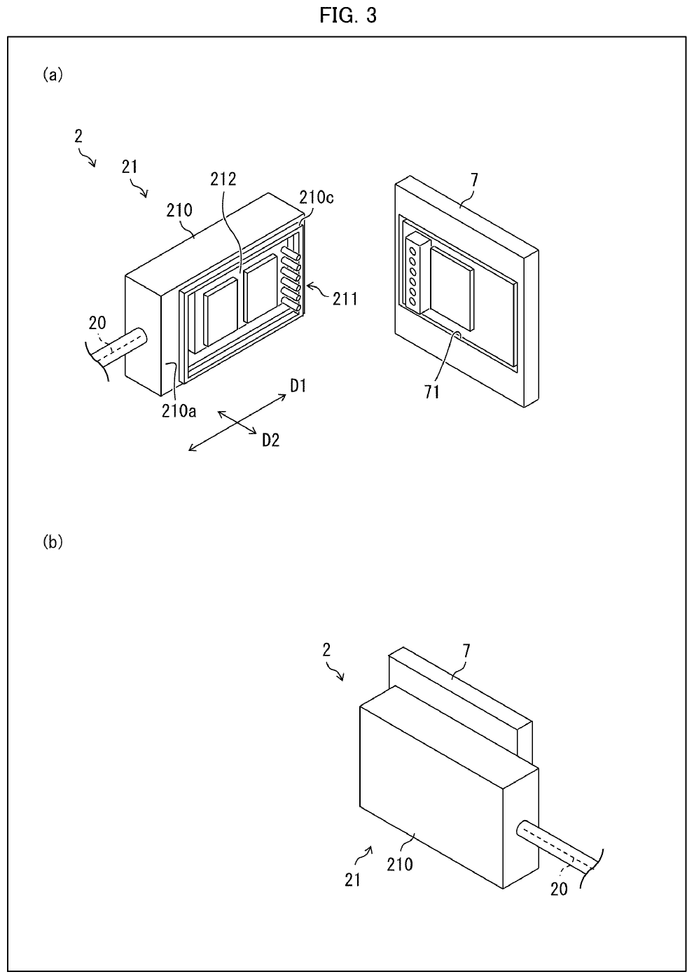

The following will discuss a cable 2 in accordance with Embodiment 2, with reference to FIG. 3. FIG. 3 is a perspective view illustrating the cable 2 together with a board 7 (one example of “device” in Claims) to which the cable 2 is connected. In FIG. 3, (a) shows a state prior to connection of the cable 2 to the board 7, while (b) shows a state after connection of the cable 2 to the board 7.

The cable 2 is a cable having at least one end (both ends in Embodiment 2) provided with a connector 21.

In Embodiment 2, the cable 2 is an active optical cable. Accordingly, the cable 2 includes an optical fiber 20 which is optically connected to the connector 21. The optical fiber 20 is an example of a transmission line described in Claims. Further, the connector 21 includes a built-in transmitting circuit (not illustrated) for converting an electrical signal outputted by the board 7 to an optical signal which is to be transmitted via the optical fiber 20, and a built-in receiving circuit (not illustrated) for converting the optical signal received via the optical fiber 20 to an electrical signal which is to be inputted to the board 7. Therefore, the cable 2 makes it possible to transmit signals faster than metal cables.

The connector 21 includes: a housing 210 to which the optical fiber 20 is connected; a board 212 on which the transmitting circuit and/or the receiving circuit is/are mounted and which is built in the housing 210; and a terminal group 211 which protrudes, from the board 212, in a direction different from a longest side direction D1 of the housing 210 (in Embodiment 2, shortest side direction D2). In the cable 2, the optical fiber 20 is led out from the housing 110 along the longest side direction D1 (parallel to the longest side direction in Embodiment 2). Therefore, the longest side direction D1 is an example of the lead-out direction described in Claims. In other words, the terminal group 211 protrudes from the board 212, in a direction different from the lead-out direction. The terminal group 211 is provided mainly for inputting, to the transmitting circuit, an electrical signal outputted by the board 7 and/or for inputting, to the board 7, an electrical signal outputted by the receiving circuit.

In Embodiment 2, the housing 210 is an open housing in which a space (hereinafter, also referred to as “internal space”) present inside the housing 210 is open in the direction in which the terminal group 211 protrudes. With this configuration, the board 212 provided inside the housing 210 is not covered by an outer wall of the housing 210 and exposed to the outside, when viewed from the direction in which the terminal group 211 protrudes.

Further, in Embodiment 2, the terminal group 211 is a terminal group which is for board-to-board connection and which is provided on the board 212. The terminal group for board-to-board connection here refers to a terminal group which is for in-device connection and which is originally intended to electrically connect boards to each other. Therefore, the terminal group 211 can transmit signals faster than a terminal group which is for inter-device connection and which is intended to connect devices to each other.

A conventional cable 5 has an end provided with a connector 51 and this connector 51 includes a terminal group 511 which protrudes in a longest side direction D1 of a housing 510. Accordingly, when the connector 51 is connected to the board 7 instead of to a device 6, the connector 51 protrudes from the board 7 by a size of the housing 510 in the longest side direction D1

In contrast, in the cable 2 in accordance with Embodiment 2, the connector 21 includes the terminal group 211 which protrudes in the direction different from the longest side direction D1 of the housing 210 (in Embodiment 2, the shortest side direction D2). Accordingly, when the connector 21 is connected to the board 7, the connector 21 protrudes from the board 7 by a size of the housing 210 in the shortest side direction D2. Therefore, the cable 2 in accordance with Embodiment 2 makes it possible to reduce a length of protrusion of the connector 21 from the board 7 as compared to the conventional cable 5, when the connector 21 is connected to the board 7. Note that the above-described board 7 may include a board on which parts are mounted, and a housing thereof.

Further, the cable 2 in accordance with Embodiment 2 is configured such that, when the connector 21 is connected to the board 7, an edge surface (one example of “first surface” in Claims) of a side wall 210a of the housing 210 comes in surface contact with a peripheral portion of a surface (one example of “second surface” in Claims) of the board 7. Therefore, it is possible to reduce damage which may occur to terminals of the connector 21 and of the board 7 in a case where the connector 21 connected to the board 7 is loose and shaky. Note that in the present specification, among six surfaces constituting surfaces of a rectangular parallelepiped member (the side wall 210a of the housing 210 is an example of the rectangular parallelepiped member), two surfaces having the largest area are each referred to as “main surface” while the other four surfaces are each referred to as “edge surface”.

The side wall 210a of the housing 210 and the surface of the board 7 may be provided, respectively, with fitting portions which are to be fitted to each other. This makes it possible to reduce a load on the terminal group 211 of the connector 21 by suppressing movement of the connector 21 in a direction parallel to the surface of the board 7, in a case where the connector 21 is connected to the board 7. FIG. 3 illustrates, as an example, a configuration in which a raised portion 210c is provided, as one of such fitting portions, on the side wall 210a of the housing 210 and a recessed portion 71 is provided, as the other one of such fitting portions, on the surface of the board 7. It should be noted that although FIG. 3 illustrates a rib-type raised portion as an example of the raised portion 210c and a groove-type recessed portion as an example of the recessed portion 71, the raised portion 210c and the recessed portion 71 are not limited to such portions. It is possible to use, for example, a pin-type raised portion as the raised portion 210c, and a pinhole-type recessed portion as the recessed portion 71.

Note that, in Embodiment 2, the terminal group 211 provided on the board 212 and the terminal group provided on the board 7 are electrically connected with each other.

Further, in the cable 2, as in the cable 1, the optical fiber 20 may be optically connected, via an optical connector, to one or both of the transmitting circuit and the receiving circuit which are built in the connector 21. Further, when the cable 2 includes a metal wire, the metal wire and the connector 11 may be electrically connected to each other via an electrical connector. In such configurations, in a case where one or both of the transmitting circuit and the reception circuit of the connector 21 need to be replaced (e.g., in a case where one or both of the transmitting circuit and the receiving circuit break down), it is possible to replace only the connector 21 without replacing the optical fiber 20.

[Image Transmission System]

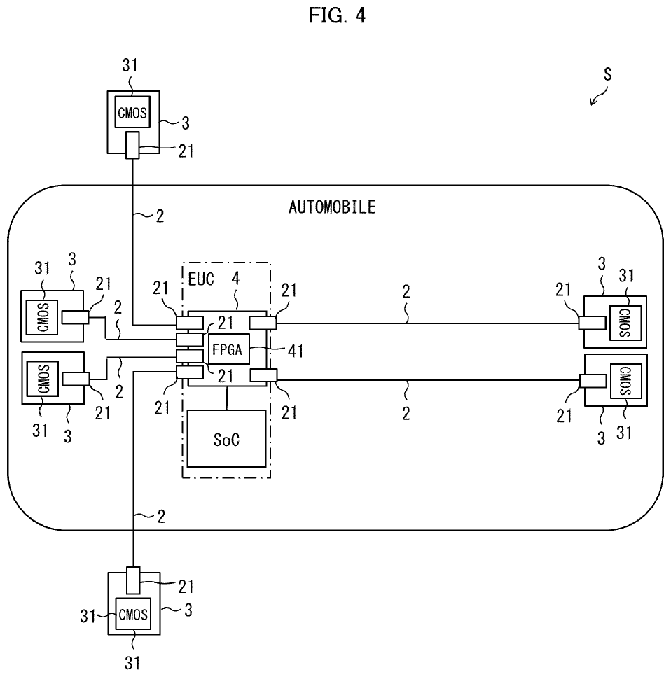

The following will discuss an image transmission system S in accordance with one or more embodiments of the present invention, with reference to FIG. 4. FIG. 4 is a block diagram illustrating a configuration of the image transmission system S.

The image transmission system S includes at least one cable 2 (six cables 2 in FIG. 4), at least one imaging board 3 (six boards 3 in FIG. 4), and at least one signal processing board 4 (one signal processing board 4 in FIG. 4), as illustrated in FIG. 4. The image transmission system S can be used, for example, as an in-vehicle image transmission system, as illustrated in FIG. 4.

The cable 2 is a cable described in Embodiment 2 and has both ends each provided with a connector 21 for connection to a board. The imaging board 3 is a board on which an image pickup element 31 (e.g., CMOSs illustrated in FIG. 4) is mounted. The imaging board 3 is connected to the connector 21 which is provided at one end of the cable 2. The signal processing board 4 is a board on which a signal processing circuit 41 (e.g., a FPGA illustrated in FIG. 4) is mounted. The signal processing circuit 41 is configured to process image signals which are generated by the image pickup element mounted on the imaging board 3 and which are transmitted via the cable 2. The signal processing board 4 is connected to the connector 21 which is provided at the other end of the cable 2. The image pickup element 31 may be any image pickup element (image sensor) and is not limited to the CMOSs. For example, the image pickup element 31 may be a CCD. Meanwhile, the signal processing circuit 41 may be any signal processing circuit, and is not limited to the FPGA.

In the image transmission system S, the imaging board 3 and the signal processing board 4 are connected to each other via the cable 2. Therefore, as compared to a case where the imaging board 3 and the signal processing board 4 are directly connected to each other by board-to-board connection, it is possible to increase a distance between the imaging board 3 and the signal processing board 4. It is thus possible to reduce: conduction of heat, which is generated in the imaging board 3 due to high-speed processing of image signals, to the signal processing board 4; and conduction of heat, which is generated in the signal processing board 4 by high-speed processing of image signals, to the imaging board 3. That is, the image transmission system S makes it possible to provide an image processing system which allows for easier disposal of heat generated by the image pickup element or the signal processing circuit, as compared with a conventional image processing system in which an image pickup element and a signal processing circuit are mounted on a single board.

Embodiment 2 describes, as an example, a configuration in which (1) the connector 21 is provided at each of both ends of the cable 2, (2) the imaging board 3 is connected to one end to the cable 2, and (3) the signal processing board 4 is connected to the other end of the cable 2. However, one or more embodiments of the present invention are not limited to such a configuration. For example, it is possible to have a configuration in which (1) the connector 21 is provided at only one end of the cable 2, and (2) the imaging board 3 is connected to this one end of the cable 2. In this case, the other end of the cable 2 may be connected, via a connector (such as a connector for device-to-device connection) different from the connector 21, to a device (e.g., the signal processing board 4) to which the cable 2 is to be connected, or may be directly connected, via no connector, to the device (e.g., the signal processing board 4) to which the cable 2 is to be connected. Alternatively, it is possible to employ a configuration in which (1) the connector 21 is provided at only one end of the cable 2, and (2) the signal processing board 4 is connected to this one end of the cable 2. In this case, the other end of the cable 2 may be connected, via a connector (such as a connector for device-to-device connection) different from the connector 21, to a device (e.g., the imaging board 3) to which the cable 2 is to be connected, or may be directly connected, via no connector, to the device (e.g., the imaging board 3) to which the cable 2 is to be connected. In other words, the connector 21 only needs to be provided at at least one end of the cable 2, and a device to which the connector 21 is to be connected may be either the imaging board 3 or the signal processing board 4. Note that in the case of employing a configuration in which the connector 21 is provided at one end of the cable 2 and a connector different from the connector 21 is provided at the other end of the cable 2, the connector different from the connector 21 provided at the other end of the cable 2 may be a connector having a specification adapted to a personal computer (PC) slot which is provided at an interface of a PC. Examples of such a connector having a specification adapted to a PC slot include a connector of a QSFP (Quad Small Form-factor Pluggable) active optical cable.

As in the image transmission system S illustrated in FIG. 4, in a case where the cable 2 is used as a part of an in-vehicle image transmission system, the optical fiber 20 may be optically connected, via an optical connector(s), to one or both of the transmitting circuit and the receiving circuit which are built in the connector 21. Further, in a case where the cable 2 includes a metal wire, the metal wire and the connector 21 may be electrically connected to each other via an electrical connector. In a case where the cable 2 is used as a part of the in-vehicle image transmission system, the optical fiber 20 is fixed to a vehicle as a part of an in-vehicle harness. It is therefore impracticable to replace the optical fiber 20 (in other words, to replace the in-vehicle harness), in order to replace one or both of the transmitting circuit and the receiving circuit of the connector 21. According to the above configuration, even in a case where the cable 2 is used as a part of the in-vehicle image transmission system, it is possible to easily replace the connector 21 which includes one or both of the transmitting circuit and the receiving circuit, without replacing the optical fiber 20.

[Recap 1]

(1) Direction in which Terminal Group Protrudes

Conventional cables employ a configuration in which a terminal group provided in a connector is protruded in a direction different from a lead-out direction in which a transmission line connected to a housing of the connector is led out. In other words, the conventional cables are configured such that the terminal group provided in the connector protrudes in a longest side direction of the connector. Accordingly, when such a conventional connector is connected to a device, the conventional connector protrudes from the device by a size of the longest side direction of the housing. This leads to, for example, be difficult to do work on the device since the connector becomes an obstacle; or the connector or the device may be easily damaged by a contact of an object with the connector.

According to one or more embodiments, the cable (1, 2) is configured such that the terminal group (111, 211) provided in the connector (11, 21) protrudes in a direction different from a lead-out direction in which the transmission line (optical fiber 10, 20) is led out from the housing (110, 210). In other words, the cable (1, 2) is configured such that the terminal group (111, 211) protrudes in a specified direction (shortest side direction (D2) in one or more embodiments of the present invention) different from the longest side direction (D1) of the connector (11, 21). The terminal group (111, 211) is provided on a surface having a largest area among six surfaces constituting surfaces of the housing (110, 210).

Therefore, the cable (1, 2) according to one or more embodiments can reduce a length of protrusion of the connector (11, 21) from a device as compared to the conventional cables, when the connector (11, 21) is connected to the device. Note that, when the concept of the lead-out direction is used, the lead-out direction of the transmission line (optical fiber 10, 20) may be the same as or different from the direction in which the terminal group (111, 211) protrudes. In other words, the terminal group (111, 211) may protrude in a direction which is the same as or different from the lead-out direction of the transmission line (optical fiber 10, 20). However, when the lead-out direction of the transmission line (optical fiber 10, 20) is different from the direction in which the terminal group (111, 211) protrudes, it is possible to reduce a length of protrusion of the transmission line (optical fiber 10, 20) from the device when the connector (11, 21) is connected to the device.

When a plurality of terminals constituting the terminal group are provided along a direction parallel to the lead-out direction of the transmission line, it is not possible to sufficiently reduce a size of the connector in the lead-out direction of the transmission line. In contrast, in the cable (1, 2) described in the present specification, a plurality of terminals constituting the terminal group (111, 211) are provided along a direction perpendicular to the lead-out direction of the transmission line (optical fiber 10, 20). In other words, the plurality of terminals constituting the terminal group (111, 211) are provided along a direction that is same as the specific direction. Therefore, it is possible to sufficiently reduce a size of the connector (11, 21) in the direction which is perpendicular to the lead-out direction of the transmission line or which is same as the specific direction.

On the other hand, assume a case where the direction in which the terminal group protrudes is perpendicular to a shortest side of the housing of the connector. In such a case, when the terminal group is connected to a surface of a device, the size of the connector cannot be sufficiently small in a direction orthogonal to the surface of the device. In contrast, in the cable (1, 2) described in the present specification, the direction in which the terminal group (111, 211) protrudes is a direction parallel to the shortest side of the housing (110, 210) of the connector (11, 21). Therefore, when the terminal group (111, 211) is connected to a surface of the device 6, it is possible to sufficiently reduce the size of the connector (11, 21) in the direction orthogonal to the surface.

Further, it is needless to say that since the terminal group (111, 211) includes a plurality of terminals, a plurality of signals can be received from or transmitted to a device (6) in a case where the terminal group (111, 211) is entirely connected to the device (6). In other words, even in the case of transmitting/receiving a plurality of signals, it is possible to easily connect to the device (6) to which the terminal group (111, 211) is to be connected.

(2) Type of Terminal Group

Recently, elements and circuits mounted on a board have advanced to achieve an increased speed of signal processing. Typical examples of such an element and such a circuit include an image pickup element mounted on an imaging board which is to be mounted on a camera or the like, and a signal processing circuit mounted on a signal processing board which is to be mounted on a computer or the like. When these two boards are directly connected to each other by board-to-board connection with use of terminal groups which are for board-to-board connection and which are provided on the two boards, respectively, heat generated in one of the boards is conducted to the other one of the boards. As a result, the element or the circuit may be damaged. One or more embodiments provide a space between the boards and connect the boards via a cable. However, the conventional cables employ a configuration in which a terminal group for device-to-device connection (such as a USB terminal group) is used as a terminal group provided in the connector. Accordingly, the connector of the conventional cables cannot be directly connected to a terminal group which is for board-to-board connection and which is provided on each of the boards. Therefore, in a case where two boards are to be connected to each other by using a conventional cable, for example, a terminal group for device-to-device connection is provided at an end of a wiring (e.g., flexible printed wiring) extending from a terminal group which is for board-to-board connection and which is provided on each of the two boards. Then, the connector of the conventional cable is connected to the terminal group. This increases both of component cost and process cost, causes or a communication rate between the two boards to be controlled by a transmission rate of the terminal group which is for device-to-device connection and which has a narrower transmission band. This is because the transmission rate of the terminal group for device-to-device connection is at most approximately 10 Gbps, which is lower than the transmission rate of the terminal group for board-to-board connection. Further, the degree of freedom in placing, on the board, the terminal group for device-to-device connection is lower than that in placing, on the board, the terminal group for board-to-board connection. Therefore, using a conventional cable for connecting two boards is impractical.

According to one or more embodiments, the cable (1, 2) employs, for the terminal group (111, 211) provided in the connector (11, 21), a configuration in which a terminal group for board-to-board connection is used.

The cable (1, 2) described in the present specification thus can be used to connect two boards that are spaced apart from each other. Therefore, according to the cable (1, 2) described in this specification, two boards can be connected to each other via the cable (1, 2) without direct board-to-board connection between the two boards. Moreover, the connector (11, 21) of the cable (1, 2) and a board are connected to each other by using a terminal group for board-to-board connection. This makes it possible to suppress an increase in component cost and process cost. Furthermore, it is possible to increase the communication speed between the two boards. In addition, a degree of freedom in placing the terminal group on each of the boards increases.

(3) Shape of Housing

Conventional cables employ a configuration in which, when a connector is connected to a device, a surface of a housing of the connector is spaced apart from a surface of a housing of the device. This is to prevent a contact between the housing of the connector and the housing of the device and to consequently prevent insufficient connection between a terminal group of the connector and a terminal group of the device, when the connector is connected to the device. However, in a case where external force is applied to the connector connected to the device and the connector becomes loose and shaky, a load may be applied to the terminal group of the connector and/or the terminal group of the device. As a result, the terminal group of the connector and/or the terminal group of the device is/are damaged.

According to one or more embodiments, the cable (1, 2) described employs a configuration in which the connector (11, 21) has a first surface that constitutes a surface of the housing (110, 210) and that, when the connector (11, 21) is connected to the device, comes in surface contact with a second surface that constitutes a surface of the device.

Therefore, according to the cable (1, 2) described in the present specification, it is possible to reduce the possibility of damage to the terminal group (111, 211) of the connector (11, 21) and/or the terminal group of the device, which damage may be caused by a load applied to the terminal group (111, 211) of the connector (11, 21) and/or the terminal group of the device in a case where the connector (11,21) becomes loose and shaky due to external force applied to the connector (11, 21) connected to the device. Further, as compared with a case where the first surface constituting the surface of the housing (110, 210) is not in contact with the second surface constituting the surface of the device, it is possible to further reduce the length of protrusion of the connector (11, 21) from the device when the connector (11, 12) is connected to the device.

(4) Indicator and/or Connecting Terminal

In the case of conventional cables, when a connector is connected to a device such as a camera, the connector may cover over an indicator and terminals which are provided on a surface of a housing of the device. In a case where the connector covers over the indicator of the device, it may be difficult for a user to check a state of the device while the connector is connected to the device. Further, in a case where the connector covers over the terminal of the device, it may be difficult to connect another device, a cable, or the like to the terminal of the device while the connector is connected to the device.

According to one or more embodiments, in the cable (1), the connector (11, 21) includes an indicator (113) that when the connector (11, 21) is connected to the device, operates in accordance with signals supplied from the device via the terminal group (111, 211).

Therefore, even while the connector (11, 21) is connected to the device (6), a user can easily check the state of the device.

According to one or more embodiments, in the cable (1), the connector (11, 21) includes a second terminal group (114) provided in a direction different from a direction in which the first terminal group (111, 211) is provided, the second terminal group (114) being provided for (1) outputting a signal that is inputted from the device (6) to the connector (11, 21) via the first terminal group (111) or (2) inputting a signal that is to be outputted from the connector (11, 21) to the device (6) via the first terminal group (111, 211) in a case where the connector (11, 21) is connected to the device (6).

Therefore, even while the connector (11, 21) is connected to the device (6), it is easy to connect another device, a cable, or the like to the device (6).

[Recap 2]

A cable (1, 2) in accordance with Aspect 1 is a cable (1, 2) including: a transmission line (optical fiber 10, 20); and a connector (11, 21) provided at at least one end of the transmission line (10, 20), the connector (11, 21) including a housing (110, 210) to which the transmission line (10, 20) is connected, and a terminal group (111, 211) protruding in a specific direction different from a direction parallel to a longest side of the housing (110, 210), the terminal group (111, 211) being a terminal group for board-to-board connection.

A cable (1, 2) in accordance with Aspect 2 employs an embodiment in which in the cable (1, 2) in accordance with Aspect 1, the terminal group (111, 211) is constituted by a plurality of terminals provided along a direction orthogonal to the direction parallel to the longest side of the housing.

A cable (1, 2) in accordance with Aspect 3 is configured such that in the cable (1, 2) in accordance with Aspect 1 or 2, the housing (110, 210) has a first surface that constitutes a surface of the housing (110, 210) and that, when the connector (11, 21) is connected to a device, comes in surface contact with a second surface that constitutes a surface of the device.

A cable (1) in accordance with Aspect 4 is configured such that in the cable (1) in accordance with Aspect 2 or 3, the housing (110) is a closed housing that has a first surface constituting a surface of the housing (110) and that has an internal space closed in the specific direction by an outer wall (110a); and the first surface is an outer surface of the outer wall (110a).

A cable (2) in accordance with Aspect 5 is configured such that in the cable (2) in accordance with Aspect 2 or 3, the housing (210) is an open housing that has a first surface constituting a surface of the housing (210) and that has an internal space open in the specific direction; and the first surface is an edge surface of a side wall (210a) of the housing (210).

A cable (1, 2) in accordance with Aspect 6 is configured to further include, in any one of Aspects 1 to 5, an optical fiber (10), the connector (11, 21) including one or both of: (1) a transmitting circuit that converts, to an optical signal to be transmitted via the optical fiber (10), an electrical signal inputted via the terminal group (111, 211); and (2) a receiving circuit that converts, to an electrical signal to be outputted via the terminal group (111, 211), the optical signal received via the optical fiber (10).

A cable (1, 2) in accordance with Aspect 7 is configured such that, in the cable (1, 2) in accordance with any one of Aspects 1 to 6, the connector (11, 21) includes an indicator (113) that, when the connector (11, 21) is connected to a device, operates in accordance with a signal supplied by the device via the terminal group (111, 211).

A cable (1) in accordance with Aspect 8 is configured such that, in the cable (1) in accordance with any one of Aspects 1 to 7, provided that the terminal group (111, 211) is defined as a first terminal group (111), the connector (11) includes a second terminal group (114) provided in a direction different from a direction in which the first terminal group (111) is provided, the second terminal group (114) being provided for (1) outputting a signal that is inputted from a device via the first terminal group (111) or (2) inputting a signal that is to be outputted to the device via the first terminal group (111) in a case where the connector (11) is connected to the device.

A cable (1, 2) in accordance with Aspect 9 is configured such that, in the cable (1, 2) in accordance with any one of Aspects 1 to 8, the connector (11, 21) has a heat dissipation mechanism (115).

A cable (1, 2) in accordance with Aspect 10 is configured such that, in the cable (1, 2) in accordance with any one of Aspects 1 to 9, the terminal group (111, 211) includes a plurality of terminals which are provided along a direction orthogonal to the direction parallel to the longest side of the housing and aligned in a row.

A cable (1, 2) in accordance with Aspect 11 is configured such that, in the cable (1, 2) in accordance with any one of Aspects 1 to 9, the terminal group (111, 211) includes a plurality of terminals which are provided along a direction orthogonal to the direction parallel to the longest side of the housing and aligned in two rows.

A cable (1, 2) in accordance with Aspect 12 is configured such that, in the cable (1, 2) in accordance with any one of Aspects 1 to 11, the number of terminals constituting the terminal group (111, 211) is four or more.

A cable (1, 2) in accordance with Aspect 13 is configured such that, in the cable (1, 2) in accordance with any one of Aspects 1 to 12, the terminal group (111, 211) is provided on a surface having a largest area among six surfaces constituting surfaces of the housing (110, 210).

An image transmission system (S) in accordance with Aspect 14 includes: a cable (1, 2) as described in any one of Aspects 1 to 13; and one or both of (I) an imaging board (3) which is connected to the cable (1, 2) via the connector (11, 21) and on which an image pickup element (31) is mounted and (II) a signal processing board (4) which is connected to the cable (1, 2) via the connector (11, 21) and on which a signal processing circuit (4) is mounted, the signal processing circuit (41) being configured to process an image signal that is generated by the image pickup element (31) and then transmitted via the cable (1, 2).

### ADDITIONAL REMARKS

The present invention is not limited to any of the foregoing embodiments, examples, and variations, but can be altered by a skilled person in the art within the scope of the claims. The present invention also encompasses, in its technical scope, any embodiment derived by combining technical means disclosed in differing embodiments, examples, or variations. Further, it is possible to form a new technical feature by combining the technical means disclosed in the embodiments, examples or variations. For example, the board 7 and the connector 21 may be connected to each other by a pin-like member in addition to the terminal group 211.
1, 2 cable
10, 20 optical fiber
11, 21 connector
110, 210 housing
110a outer wall
210a side wall
111, 211 terminal group
D1 longest side direction
D2 shortest side direction

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

1. A cable comprising:
a transmission line; and
a connector disposed on at least one end of the transmission line, wherein
the connector includes:
a housing to which the transmission line is connected; and
a terminal group that protrudes in a specific direction different from a direction parallel to a longest side of the housing,
the terminal group is a terminal group for board-to-board connection.

2. The cable as set forth in claim 1, wherein the terminal group is constituted by a plurality of terminals provided along a direction orthogonal to the direction parallel to the longest side of the housing.

3. The cable as set forth in claim 1, wherein the housing has a first surface that constitutes a surface of the housing and that, when the connector is connected to a device, comes in surface contact with a second surface that constitutes a surface of the device.

4. The cable as set forth in claim 2, wherein
the housing is a closed housing that has a first surface constituting a surface of the housing and that has an internal space closed in the specific direction by an outer wall, and
the first surface is an outer surface of the outer wall.

5. The cable as set forth in claim 2, wherein
the housing is an open housing that has a first surface constituting a surface of the housing and that has an internal space open in the specific direction, and
the first surface is an edge surface of a side wall of the housing.

6. The cable as set forth in claim 1, further comprising:
an optical fiber, wherein
the connector further includes one or both of:
a transmitting circuit that converts, to an optical signal to be transmitted via the optical fiber, an electrical signal inputted via the terminal group; and
a receiving circuit that converts, to an electrical signal to be outputted via the terminal group, the optical signal received via the optical fiber.

7. The cable as set forth in claim 1, wherein the connector includes an indicator that, when the connector is connected to a device, operates in accordance with a signal supplied by the device via the terminal group.

8. The cable as set forth in claim 1, wherein
the terminal group is defined as a first terminal group,
the connector includes a second terminal group disposed in a direction different from a direction in which the first terminal group is provided,
when the connector is connected to a device, the second terminal group:
outputs a signal that is inputted from the device via the first terminal group; or
inputs a signal that is to be outputted to the device via the first terminal group.

9. The cable as set forth in claim 1, wherein the connector has a heat dissipation mechanism.

10. The cable as set forth in claim 1, wherein the terminal group includes a plurality of terminals disposed along a direction orthogonal to the direction parallel to the longest side of the housing and aligned in a row.

11. The cable as set forth in claim 1, wherein the terminal group includes a plurality of terminals disposed along a direction orthogonal to the direction parallel to the longest side of the housing and aligned in two rows.

12. The cable as set forth in claim 1, wherein the number of terminals constituting the terminal group is four or more.

13. The cable as set forth in claim 1, wherein the terminal group is provided on a surface having a largest area among six surfaces constituting surfaces of the housing.

14. An image transmission system comprising:
a cable as set forth in claim 1; and
one or both of:
an imaging board connected to the cable via the connector and on which an image pickup element is mounted; and
a signal processing board connected to the cable via the connector and on which a signal processing circuit is mounted, wherein
the signal processing circuit processes an image signal that is generated by the image pickup element and then transmitted via the cable.
